(19) United States
(12) Patent Application Publication
(10) Pub. No.: US 2005/0020431 A1
(43) Pub. Date: Jan. 27, 2005

(54) Silicon carbide-based, porous structural material being heat-resistant and super lightweight

(76) Inventor: Eiji Tani, Tosu-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/485,119

(22) PCT Filed: Aug. 5, 2002
(86) PCT No.: PCT/JP02/07950

(30) Foreign Application Priority Data
Aug. 7, 2001 (JP) 2001-238547
Aug. 20, 2001 (JP) 2001-248484

(51) Int. Cl. C04B 35/565

(52) U.S. Cl. 501/88; 264/682; 264/44; 264/643

(57) ABSTRACT

The present invention provides a silicon carbide-based heat-resistant, ultra lightweight, porous structural material having the same shape as that of a spongy porous body and also provides a process for readily producing the material. In the process of the present invention, slurry containing silicon powder and a resin is applied to the framework of the spongy porous body by an impregnation method in such a manner that interconnected pores of the porous body are not plugged with the slurry; the resulting porous body is carbonized at a temperature of 900° C. to 1320° C. in vacuum or in an inert atmosphere; the resulting porous body is subjected to reactive sintering at a temperature of 1320° C. or more in vacuum or in an inert atmosphere, whereby silicon carbide having high wettability to molten silicon is produced and open pores due to a volume reduction reaction are formed in one step; and molten silicon is infiltrated into the resulting porous body at a temperature of 1300° C. to 1800° C. in vacuum or in an inert atmosphere, whereby the silicon carbide-based heat-resistant, ultra-lightweight, porous structural material is produced.

### TECHNICAL FIELD

The present invention relates to silicon carbide-based heat-resistant, ultra-lightweight, porous structural materials having a sponge structure with interconnected pores, the materials being produced by a two-step reactive sintering process including a step of sintering silicon and carbon and a step of infiltrating molten silicon into the sintered body, and also relates to processes for producing the materials. The present invention particularly relates to a heat-resistant, ultra-lightweight, porous structural material fit for various applications such as high-temperature filters, high-temperature structural members, heat insulators, filters for molten metal, burner plates, heater members, and high-temperature sound absorbers and also relates to a process for producing the material.

### BACKGROUND ART

Silicon carbide ceramics are light in weight and excellent in heat resistance, abrasion resistance, corrosion resistance, and so on. Therefore, such ceramics have been recently used in various applications such as high-temperature corrosion-resistant members, heater members, abrasion-resistant members, abrasives, and grindstones. Since the ceramics are principally produced by a sintering process, they have not been in practical use as ultra-lightweight porous members having a porosity of 90% or more and a filter shape.

In recent years, the porous ceramics having heat resistance and ultra lightweight have been investigated. For example, Bridgestone Corporation has succeeded in producing a porous silicon carbide structure used for ceramic foam filters for cast iron according to the following procedure: a sponge is impregnated with silicon carbide slurry, and an excess of the slurry is removed from the resulting sponge, which is dried and then fired. According to a catalogue showing properties, the porous silicon carbide structure has a porosity of 85% and an apparent specific gravity of 0.42.

In the above procedure, since the slurry containing silicon carbide powder is used, some pores are plugged with the remaining slurry although an excess of the slurry is removed from the sponge. Therefore, the porosity is 85%, which is a small value, and the apparent specific gravity is 0.42, which is a large value. Furthermore, the pore size is about 1-5 mm (the standard number of cells ranges from 13 per 25 mm to six per mm), which is a large value.

On the other hand, the inventors have obtained the following finding in the investigation of a fiber-reinforced silicon carbide composite material: molten silicon hardly reacts with a dense matrix, prepared by the carbonization of a phenol resin, containing only amorphous carbon but readily permeate a porous matrix and reacts therewith, wherein the porous matrix contains residual amorphous carbon and silicon carbide that is produced by the reactive sintering (volume reduction reaction) of a mixture of silicon powder and a phenol resin and has high wettability to the molten silicon, as disclosed in Japanese Patent No. 3096716. Furthermore, the inventors have found that this technique can be used for producing an ultra-lightweight, porous structural material.

### DISCLOSURE OF INVENTION

In order to overcome disadvantages of known silicon carbide-based heat-resistant, lightweight, porous materials and processes for producing the materials, the present invention has been made based on the above findings. The present invention provides a silicon carbide-based heat-resistant, ultra lightweight, porous structural material and a process for producing the material, wherein the material has uniform pores therein, a porosity of 80% or more, and a density of 0.3 g/cm³ or less. The material can be readily produced in such a manner that the shape of the framework of a porous body is maintained even if the shape is complicated.

As a result of an intensive investigation on the silicon carbide-based heat-resistant, ultra-lightweight, porous structural material, the inventors have found that the material can be readily produced in such a manner that the shape of the framework of the porous body is maintained even if the shape is complicated according to the following procedure: silicon powder and a resin are allowed to adhere to the framework of the porous body such as a sponge by an impregnation method, porous silicon carbide and residual carbon are produced from the silicon powder and resin by the silicon carbide production reaction in which volume reduction occurs, and molten silicon is then infiltrated into the pores. The present invention has thereby been completed.

The silicon carbide-based heat-resistant, ultra-lightweight, porous structural material of the present invention completed as described above contains silicon carbide having high wettability to molten silicon and silicon provided in a carbonized porous sintered body, having open pores formed due to a volume reduction reaction, by melt infiltration. The carbonized porous sintered body is formed by the reactive sintering of a carbonized porous body formed by carbonizing a spongy porous body made of plastic or paper for forming a framework, the porous body being impregnated with slurry containing silicon powder and a resin functioning as a carbon source in such a manner that interconnected pores of the porous body are not plugged with the slurry.

A process for producing the silicon carbide-based heat-resistant, ultra-lightweight, porous structural material of the present invention includes a step of applying slurry, containing silicon powder and a resin functioning as a carbon source, to the framework of a spongy porous body made of plastic or paper by an impregnation method in such a manner that interconnected pores of the porous body are not plugged with the slurry; a step of carbonizing the resulting porous body at a temperature of 900° C. to 1320° C. in vacuum or in an inert atmosphere; a step of subjecting the resulting porous body to reactive sintering at a temperature of 1320° C. or more in vacuum or in an inert atmosphere, whereby silicon carbide having high wettability to molten silicon is produced and open pores due to a volume reduction reaction are formed in one step; and a step of infiltrating molten silicon into the resulting porous body at a temperature of 1300° C. to 1800° C. in vacuum or in an inert atmosphere.

In the above process, the reactive sintering of silicon and carbon and the melt infiltration of silicon may be performed in the same heat-treating step and all heat-treating operations including the carbonization may be performed in the same step.

According to the process of the present invention, large-sized structures with a complicated shape can be readily produced and porous bodies can be readily machined after the carbonization thereof.

In the above process, in order to impregnate the porous body with the slurry in such a manner that the interconnected pores are not plugged with the slurry, the following procedure is effective: the slurry containing the resin and silicon powder is applied to the framework of the porous body by an impregnation method and the slurry is then wrung out of the resulting porous body. Examples of a method for wring the slurry include a compression method and a method using the centrifugal force.

In the above process, a material for forming the framework of the spongy porous body preferably retains the slurry and examples of such a material include a sponge containing a resin or rubber, spongy plastic, and spongy paper.

In the above process, examples of the resin allowed to adhere to the framework of the porous body by an impregnation method include a phenol resin, a furan resin, an organic metal polymer such as polycarbosilane, and sucrose. These materials may be used alone or in combination. Examples of the additive include carbon powder, graphite powder, and carbon black. Examples of the aggregate or oxidation inhibitor include silicon carbide, silicon nitride, zirconia, zirconium, alumina, silica, mullite, molybdenum silicide, boron carbide, and boron powder.

In the above process, the silicon powder contained in the slurry may contain a silicon alloy containing at least one selected from the group consisting of magnesium, aluminum, titanium, chromium, manganese, iron, cobalt, nickel, copper, zinc, zirconium, niobium, molybdenum, and tungsten or the slurry may contain a mixture of the silicon powder and those metals. Furthermore, silicon for melt infiltration may be a pure silicon metal or may be derived from a silicon alloy containing one selected from the group consisting of magnesium, aluminum, titanium, chromium, manganese, iron, cobalt, nickel, copper, zinc, zirconium, niobium, molybdenum, and tungsten or derived from a mixture of silicon and those metals.

According to the silicon carbide-based heat-resistant, ultra-lightweight, porous structural material and production process of the present invention, the slurry containing the silicon powder and the resin functioning as a carbon source is applied to the framework of the spongy porous body by an impregnation method in such a manner that the interconnected pores of the porous body are not plugged with the slurry, silicon carbide having high wettability to molten silicon and the open pores are formed by the reactive sintering, and molten silicon is then infiltrated into the pores. Therefore, a silicon carbide-based heat-resistant, lightweight, porous composite material having the same shape as that of the porous structural material can be readily produced. Thus, the porous composite material can be readily produced even if it has a complicated shape.

### BEST MODE FOR CARRYING OUT THE INVENTION

Preferred embodiments of the present invention will now be described.

In a process of the present invention, slurry is prepared by mixing silicon powder with a dissolved resin, such as a phenol resin, functioning as a carbon source; the slurry is sufficiently applied onto the framework of a spongy, porous structural material or the porous structural material is immersed in the slurry such that the porous structural material is impregnated with the slurry; the slurry is wrung out of the resulting porous structural material in such a manner that interconnected pores of the porous structural material are not plugged with the slurry; and the resulting porous structural material is then dried. The porous structural material is preferably dried at about 70° C. for about 12 hours.

Examples of the porous structural material include sponges containing a resin or rubber, spongy plastics, and spongy paper.

The resin allowed to adhere to the framework of the porous structural material is at least one selected from the group consisting of a phenol resin, a furan resin, an organic metal polymer, and sucrose. The resin may contain the above additive and the like according to needs.

The silicon powder for forming silicon carbide preferably has a fine particle size. In particular, the average particle size is preferably 30 μm or less. The silicon powder having a large particle size may be pulverized in a ball mill.

Next, the resulting porous structural material is carbonized at a temperature of 900-1320° C. in vacuum or in an inert atmosphere such as an argon atmosphere. In this operation, the spongy porous structural material is thermally decomposed, whereby a carbonized composite material is obtained. The framework of the carbonized composite material contains carbon produced by the carbonization of the phenol resin and the silicon powder, the carbon and silicon powder being mixed together. The shape of the carbonized composite material is the same as that of the porous structural material. The carbonized porous structural material has a strength sufficient for machining.

The carbonized porous structural material is fired at a temperature of 1320° C. or more in vacuum or in an inert atmosphere such as an argon atmosphere such that carbon reacts with silicon, whereby porous silicon carbide having high wettability to molten silicon is formed on the framework of the material. Since the volume is reduced in this reaction, open pores are formed due to the volume reduction reaction. This results in a porous sintered body having a matrix portion containing porous silicon carbide and residual carbon.

The porous sintered body is heated to a temperature of 1300-1800° C. in vacuum or in an inert atmosphere, and molten silicon is infiltrated into porous portions of the framework containing silicon carbide and carbon, whereby a silicon carbide-based heat-resistant, ultra-lightweight, porous structural material is obtained.

According to the present invention, in the mixture of the silicon powder and carbon derived from the resin, the molar ratio of silicon to carbon is preferably within a range of 0.05 to 4.

### EXAMPLES

A process of the present invention will now be described in detail with reference to examples. The present invention is not limited to the examples.

### Example 1

The mixing ratio of a phenol resin to silicon powder was set such that the molar ratio of carbon formed by the carbonization of the phenol resin to silicon is five to three. The phenol resin was dissolved in ethyl alcohol, thereby preparing slurry. In order to reduce the size of the silicon particles, the slurry was mixed in a ball mill for one day. The slurry was infiltrated into a polyurethane sponge having pores with a size of 500-600 μm. The resulting sponge was wrung in such a manner that the interconnected pores are not plugged with the slurry. The resulting sponge was then dried. In this operation, the sponge was expanded in the axial direction by about 20%.

The resulting sponge was fired at 1000° C. for one hour in an argon atmosphere, thereby carbonizing the sponge. The obtained carbonaceous porous body was heated at 1450° C. for one hour in vacuum, thereby performing reactive sintering and the melt infiltration of silicon in one step. A silicon carbide-based heat-resistant, ultra-lightweight, porous structural material having the same shape as that of the sponge was then obtained. In the carbonizing operation, the sponge was slightly reduced in size because the carbonized sponge shrunk in the axial direction by about 12% as compared with the untreated sponge.

The obtained porous structural material had the same structure as that of the sponge and also had a pore diameter of 500-600 μm, a porosity of 97%, and a density of 0.07 g/cm³. The porous structural material did not have plugged pores.

### Example 2

The mixing ratio of a phenol resin to silicon powder was set such that the molar ratio of carbon formed by the carbonization of the phenol resin to silicon is five to three. The phenol resin was dissolved in ethyl alcohol, thereby preparing slurry. In order to reduce the size of the silicon particles, the slurry was mixed in a ball mill for one day. The slurry was infiltrated into a polyurethane sponge having pores with a size of about one mm. The resulting sponge was wrung in such a manner that the interconnected pores are not plugged with the slurry. The resulting sponge was then dried. In this operation, the sponge was expanded in the axial direction by about 20%.

The resulting sponge was fired at 1000° C. for one hour in an argon atmosphere, thereby carbonizing the sponge. The obtained carbonaceous porous body was heated at 1450° C. for one hour in vacuum, thereby performing reactive sintering and the melt infiltration of silicon in one step. A silicon carbide-based heat-resistant, ultra-lightweight, porous structural material having the same shape as that of the sponge was then obtained. In the carbonizing operation, the sponge was slightly reduced in size because the carbonized sponge shrunk in the axial direction by about 12% as compared with the untreated sponge.

The obtained porous structural material had the same structure as that of the sponge and also had a pore diameter of about one mm, a porosity of 97%, and a density of 0.06 g/cm³.

### Example 3

The mixing ratio of a phenol resin to silicon powder was set such that the molar ratio of carbon formed by the carbonization of the phenol resin to silicon is five to three. The phenol resin was dissolved in ethyl alcohol, thereby preparing slurry. In order to reduce the size of the silicon particles, the slurry was mixed in a ball mill for one day. The slurry was infiltrated into a polyurethane sponge having pores with a size of about 1.5-2 mm. The resulting sponge was wrung in such a manner that the interconnected pores are not plugged with the slurry. The resulting sponge was then dried. In this operation, the sponge was hardly expanded.

The resulting sponge was fired at 1000° C. for one hour in an argon atmosphere, thereby carbonizing the sponge. The obtained carbonaceous porous body was heated at 1450° C. for one hour in vacuum, thereby performing reactive sintering and the melt infiltration of silicon in one step. A silicon carbide-based heat-resistant, ultra-lightweight, porous structural material having the same shape as that of the sponge was then obtained. In the carbonizing operation, the sponge was slightly reduced in size because the carbonized sponge shrunk in the axial direction by about 12%.

The obtained porous structural material had the same structure as that of the sponge and also had a pore diameter of about 1.5-2 mm, a porosity of 95%, and a density of 0.1 g/cm³.

### Comparative Example 1

The same sponge as that used in Example 1 was fired at 1000° C. for one hour in an argon atmosphere. As a result, the sponge was vanished. Comparative Example 2

A phenol resin was dissolved in ethyl alcohol, thereby preparing slurry. The slurry was infiltrated into a polyurethane sponge having a pore diameter of 500-600 μm. The resulting sponge was wrung in such a manner that the interconnected pores are not plugged with the slurry. The resulting sponge was then dried.

The resulting sponge was fired at 1000° C. for one hour in an argon atmosphere, thereby carbonizing the sponge. The obtained carbonaceous porous body was heated at 1450° C. for one hour in vacuum, thereby performing reactive sintering and the melt infiltration of silicon in one step. However, the infiltration of silicon did not occur. Therefore, the carbonaceous porous body remained as it was.

Industrial Applicability

As described above in detail, according to a silicon carbide-based heat-resistant, ultra-lightweight, porous structural material of the present invention, a silicon carbide-based heat-resistant, lightweight, porous composite material having the same shape as that of the porous structural material can be produced. Therefore, the porous composite material can be readily produced even if it has a complicated shape. Thus, the porous structural material can be used in various applications such as high-temperature filters, high-temperature structural members, heat insulators, filters for molten metal, burner plates, heater members, and high-temperature sound absorbers.

1. A silicon carbide-based heat-resistant, ultra lightweight, porous structural material containing silicon carbide having high wettability to molten silicon and silicon provided in a carbonized porous sintered body, having open pores formed due to a volume reduction reaction, by melt infiltration,
wherein the carbonized porous sintered body is formed by the reactive sintering of a carbonized porous body formed by carbonizing a porous body made of plastic or paper for forming a framework, the porous body being impregnated with slurry containing silicon powder and a resin functioning as a carbon source in such a manner that interconnected pores of the porous body are not plugged with the slurry.

2. The porous composite material heat-resistant, ultra lightweight, porous structural material according to claim 1, wherein the resin, allowed to adhere to the framework by an impregnation method, functioning as a carbon source is at least one selected from the group consisting of a phenol resin, a furan resin, an organic metal polymer, and sucrose.

3. The porous composite material heat-resistant, ultra lightweight, porous structural material according to claim 1, wherein the slurry applied to the framework by an impregnation method contains an additive selected from the group consisting of carbon powder, graphite powder, and carbon black.

4. The porous composite material heat-resistant, ultra lightweight, porous structural material according to claim 1, wherein the slurry applied to the framework by an impregnation method contains an aggregate or oxidation inhibitor that is at least one selected from the group consisting of silicon carbide, silicon nitride, zirconia, zirconium, alumina, silica, mullite, molybdenum silicide, boron carbide, and boron powder.

5. The porous composite material heat-resistant, ultra lightweight, porous structural material according to claim 1, wherein the silicon powder contained in the slurry contains a silicon alloy containing at least one selected from the group consisting of magnesium, aluminum, titanium, chromium, manganese, iron, cobalt, nickel, copper, zinc, zirconium, niobium, molybdenum, and tungsten or the slurry contains a mixture of the silicon powder and those metals.

6. The porous composite material heat-resistant, ultra lightweight, porous structural material according to claim 1, wherein silicon for melt infiltration is derived from a silicon alloy containing at least one selected from the group consisting of magnesium, aluminum, titanium, chromium, manganese, iron, cobalt, nickel, copper, zinc, zirconium, niobium, molybdenum, and tungsten or derived from a mixture of silicon and those metals.

7. A process for producing a silicon carbide-based heat resistant, ultra lightweight, porous structural material comprising a step of applying slurry, containing silicon powder and a resin functioning as a carbon source, to the framework of a spongy porous body, made of plastic or paper, by an impregnation method in such a manner that interconnected pores of the porous body are not plugged with the slurry; a step of carbonizing the resulting porous body at a temperature of 900° C. to 1320° C. in vacuum or in an inert atmosphere; a step of subjecting the resulting porous body to reactive sintering at a temperature of 1320° C. or more in vacuum or in an inert atmosphere, whereby silicon carbide having high wettability to molten silicon is produced and open pores due to a volume reduction reaction are formed in one step; and a step of infiltrating molten silicon into the resulting porous body at a temperature of 1300° C. to .1800° C. in vacuum or in an inert atmosphere.

8. The process for producing a silicon carbide-based heat resistant, ultra lightweight, porous structural material according to claim 7, further comprising a step of wring the slurry, applied to the framework, containing the silicon powder and the resin, out of the porous body such that the interconnected pores of the porous body are not plugged with the slurry.

9. The process for producing a silicon carbide-based heat resistant, ultra lightweight, porous structural material according to claim 7, wherein the resin allowed to adhere to the framework of the porous body by an impregnation method is at least one selected from the group consisting of a phenol resin, a furan resin, an organic metal polymer, and sucrose.

10. The process for producing a silicon carbide-based heat resistant, ultra lightweight, porous structural material according to claim 7, wherein the slurry applied to the framework of the porous body by an impregnation method contains an additive selected from the group consisting of carbon powder, graphite powder, and carbon black.

11. The process for producing a silicon carbide-based heat resistant, ultra lightweight, porous structural material according to claim 7, wherein the slurry applied to the framework of the porous body by an impregnation method contains an aggregate or oxidation inhibitor that is at least one selected from the group consisting of silicon carbide, silicon nitride, zirconia, zirconium, alumina, silica, mullite, molybdenum silicide, boron carbide, and boron powder.

12. The process for producing a silicon carbide-based heat resistant, ultra lightweight, porous structural material according to claim 7, wherein the silicon powder contained in the slurry contains a silicon alloy containing at least one selected from the group consisting of magnesium, aluminum, titanium, chromium, manganese, iron, cobalt, nickel, copper, zinc, zirconium, niobium, molybdenum, and tungsten or the slurry contains a mixture of the silicon powder and those metals.

13. The process for producing a silicon carbide-based heat resistant, ultra lightweight, porous structural material according to claim 7, wherein the silicon for melt infiltration is derived from a silicon alloy containing at least one selected from the group consisting of magnesium, aluminum, titanium, chromium, manganese, iron, cobalt, nickel, copper, zinc, zirconium, niobium, molybdenum, and tungsten or derived from a mixture of silicon and those metals.

14. The process for producing a silicon carbide-based heat resistant, ultra lightweight, porous structural material according to claim 8, wherein the resin allowed to adhere to the framework of the porous body by an impregnation method is at least one selected from the group consisting of a phenol resin, a furan resin, an organic metal polymer, and sucrose.

15. The process for producing a silicon carbide-based heat resistant, ultra lightweight, porous structural material according to claim 8, wherein the slurry applied to the framework of the porous body by an impregnation method contains an additive selected from the group consisting of carbon powder, graphite powder, and carbon black.

16. The process for producing a silicon carbide-based heat resistant, ultra lightweight, porous structural material according to claim 8, wherein the slurry applied to the framework of the porous body by an impregnation method contains an aggregate or oxidation inhibitor that is at least one selected from the group consisting of silicon carbide, silicon nitride, zirconia, zirconium, alumina, silica, mullite, molybdenum silicide, boron carbide, and boron powder.

17. The process for producing a silicon carbide-based heat resistant, ultra lightweight, porous structural material according to claim 8, wherein the silicon powder contained in the slurry contains a silicon alloy containing at least one selected from the group consisting of magnesium, aluminum, titanium, chromium, manganese, iron, cobalt, nickel, copper, zinc, zirconium, niobium, molybdenum, and tungsten or the slurry contains a mixture of the silicon powder and those metals.

18. The process for producing a silicon carbide-based heat resistant, ultra lightweight, porous structural material according to claim 8 wherein the silicon for melt infiltration is derived from a silicon alloy containing at least one selected from the group consisting of magnesium, aluminum, titanium, chromium, manganese, iron, cobalt, nickel, copper, zinc, zirconium, niobium, molybdenum, and tungsten or derived from a mixture of silicon and those metals.
